(19) United States
(12) Patent Application Publication
(10) Pub. No.: US 2017/0147969 A1
(43) Pub. Date: May 25, 2017

(54) INVENTORY MANAGEMENT SYSTEM

(71) Applicant: FASTENAL IP COMPANY, Winona, MN (US)

(72) Inventors: Sridhar Narsingh, Winona, MN (US); Matthew Allyn McNally, LaCresent, MN (US); Lee Travis Zenke, Pittsboro, IN (US); Jeremy Lee Johnson, Winona, MN (US); Kyle James Rasmussen, Goodview, MN (US)

(73) Assignee: FASTENAL IP COMPANY, Winona, MN (US)

(21) Appl. No.: 15/354,768

(22) Filed: Nov. 17, 2016

Related U.S. Application Data
(60) Provisional application No. 62/257,961, filed on Nov. 20, 2015.

(51) Int. Cl. G06Q 10/08; G06K 7/10

(52) U.S. Cl. CPC G06Q 10/087; G06K 7/10297

(57) ABSTRACT

The present disclosure provides a system and method of live inventory management. The system includes a plurality of bins that include a plurality of specifically located level sensors and a controller that aggregates the data from the sensors to push to the host server, which ascertains the inventory state of the bins and generates alerts when the bins require replenishment. The method includes the step of automatically generating alerts for replenishment based upon the data from the plurality of level sensors.

### REFERENCE TO COPENDING APPLICATIONS

This application is a nonprovisional which claims the benefit of provisional application Ser. No. 62/257,961 filed Nov. 20, 2015, which are incorporated herein by reference in their entirety.

### BACKGROUND

Manufacturing facilities often use bins on shelves to organize and store fasteners. Keeping track of whether the bins are sufficiently full or require replenishment can be a laborious tedious process. Automated systems have been developed to improve efficiency. One such system is Fastenal's FAST Scale system that involves placing the bins on scales. The system ascertains the inventory level in the bins based on the weight of the bin as the weight is greatest when the bin is full and least when the bin is empty. Such a system requires calibration to correlate the bin weight to the bin level as the relationship varies for the particular material that is stored in the bin. There is a need in the art for a system that is less costly and easier to use.

### SUMMARY

The present disclosure provides a system and method of live inventory management. The system includes a plurality of bins that include a plurality of specifically located sensors and a controller that aggregates the data from the sensors to push to the host server, which ascertains the inventory state of the bins and generates alerts when the bins require replenishment. The method includes the step of automatically generating alerts for replenishment based upon the data from the plurality of level sensors.

### BRIEF DESCRIPTION OF THE DRAWINGS

FIG. 1 is a perspective view of an embodiment of the inventory management system of the present disclosure;

FIG. 2 is an assembly view of a bin of the inventory management system of the present disclosure;

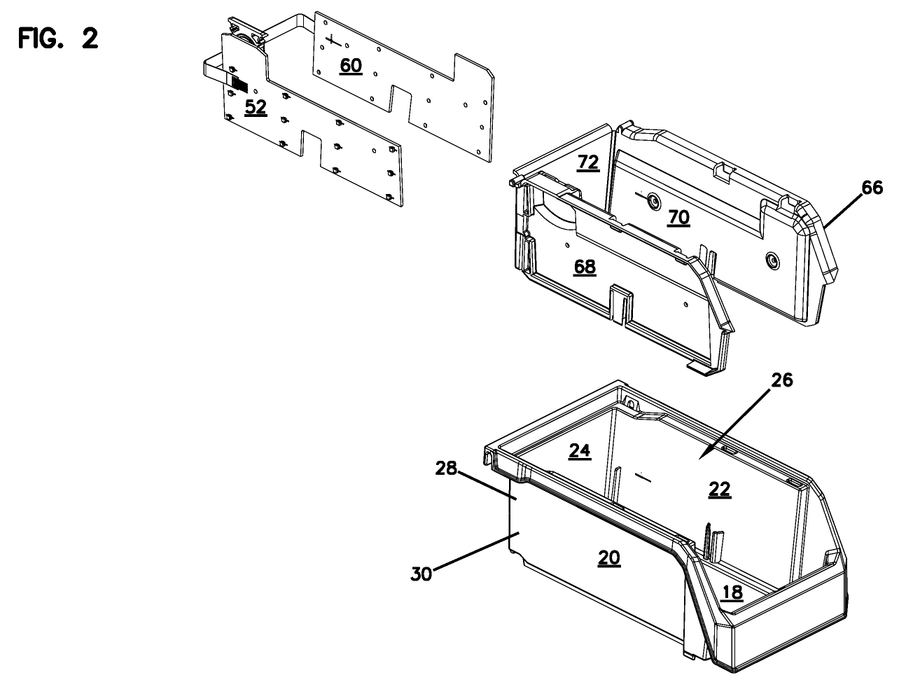

FIG. 3 is a first perspective view of a component of the bin of FIG. 2;

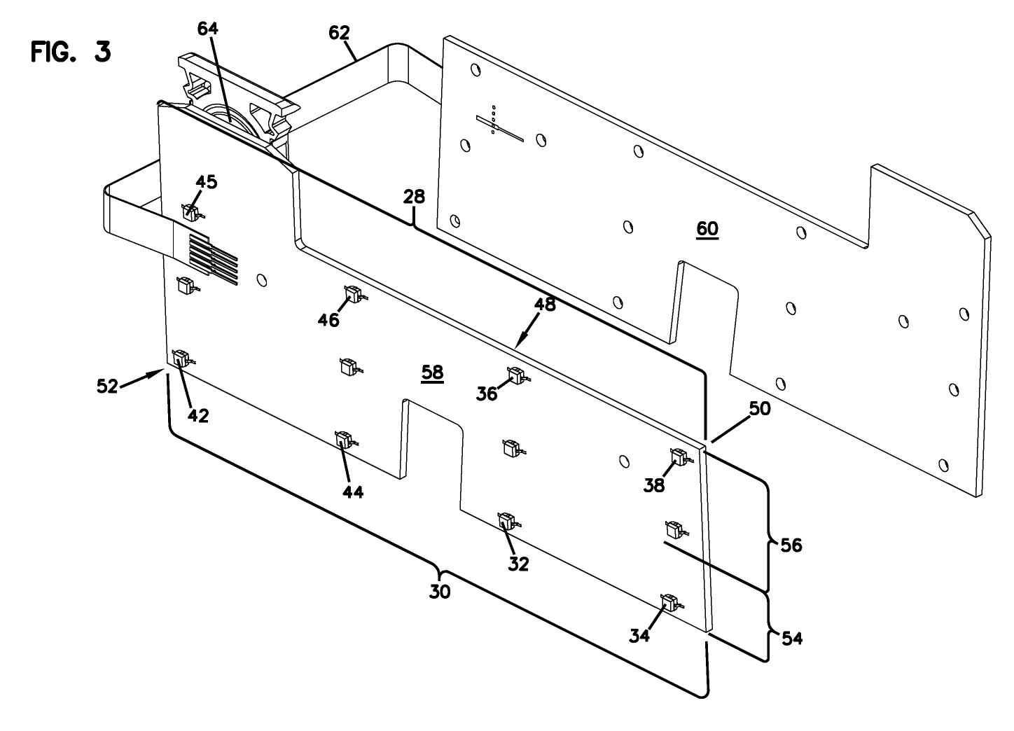

FIG. 4 is a first perspective view of a component of the bin of FIG. 2;

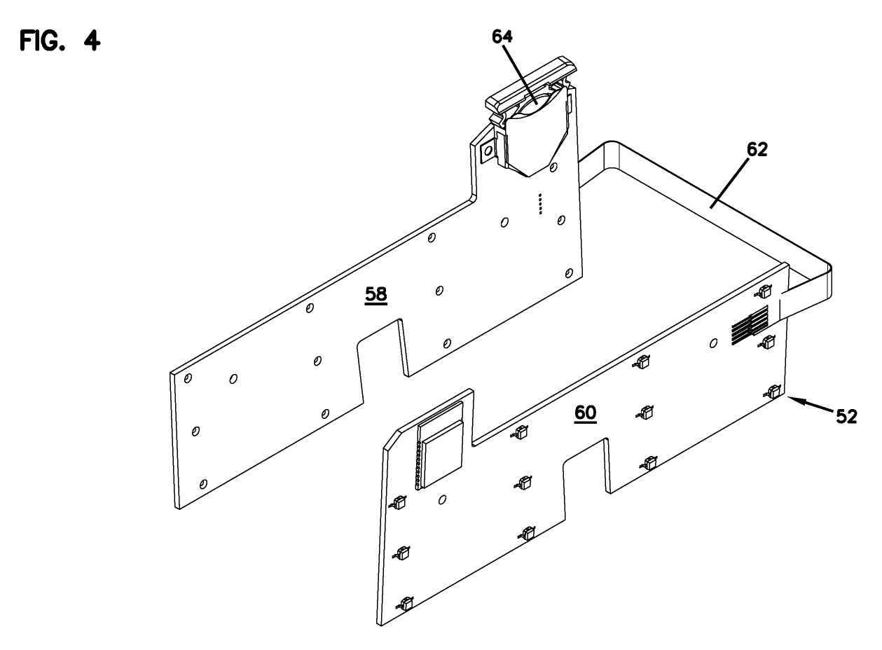

FIG. 5 is perspective view of a component of the bin of FIG. 2;

FIG. 6 is perspective view of a component of the inventory management system of the present disclosure;

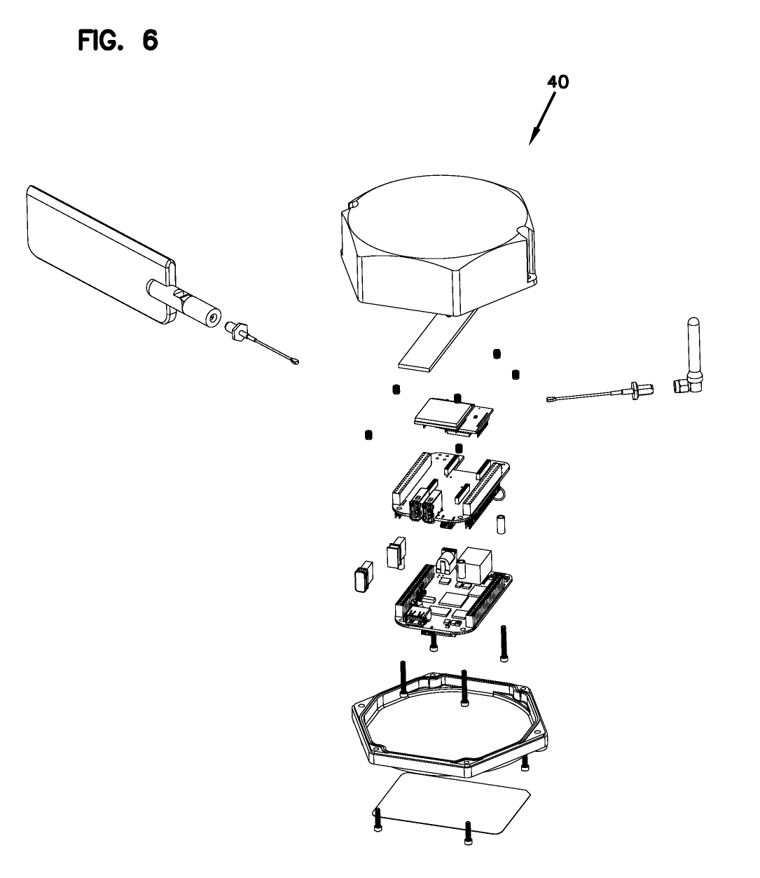

FIG. 7 is perspective view of a component of the inventory management system of the present disclosure; and

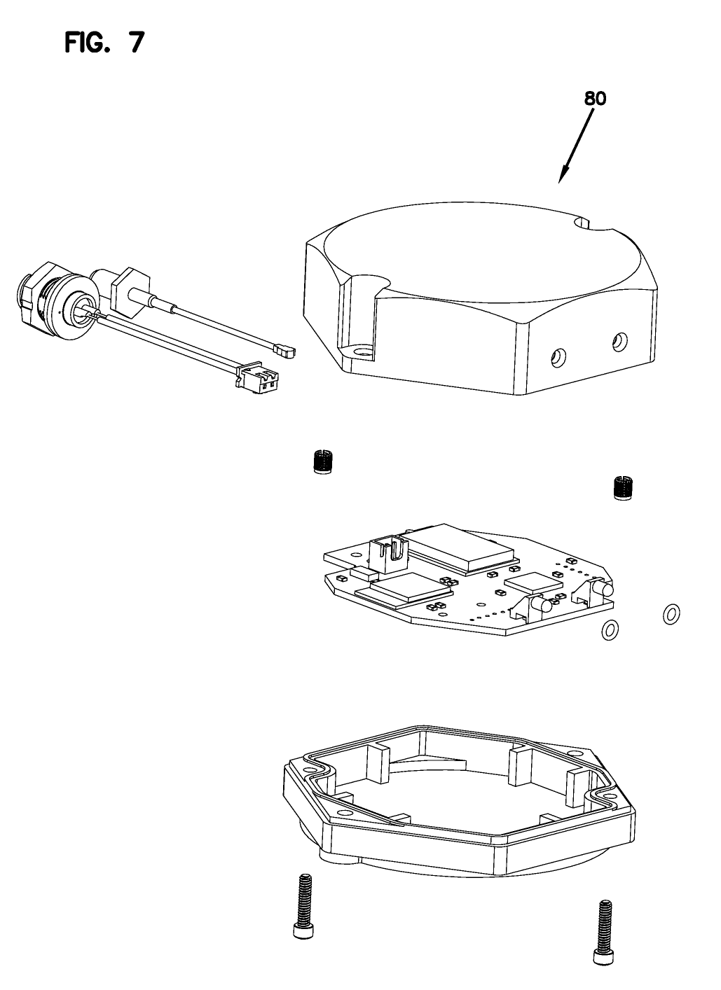

FIG. 8 is perspective view of a component of the inventory management system of the present disclosure.

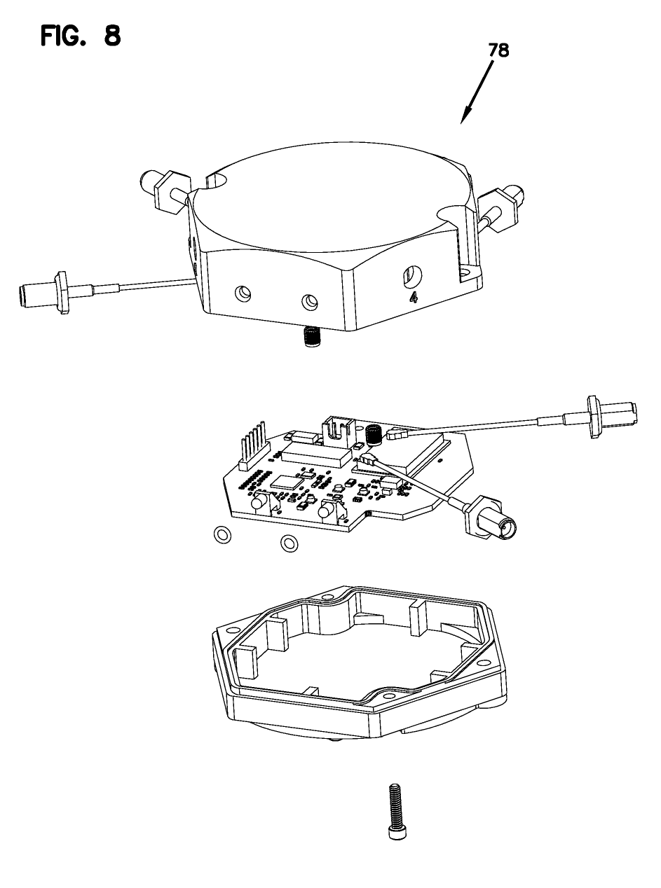

### DETAILED DESCRIPTION

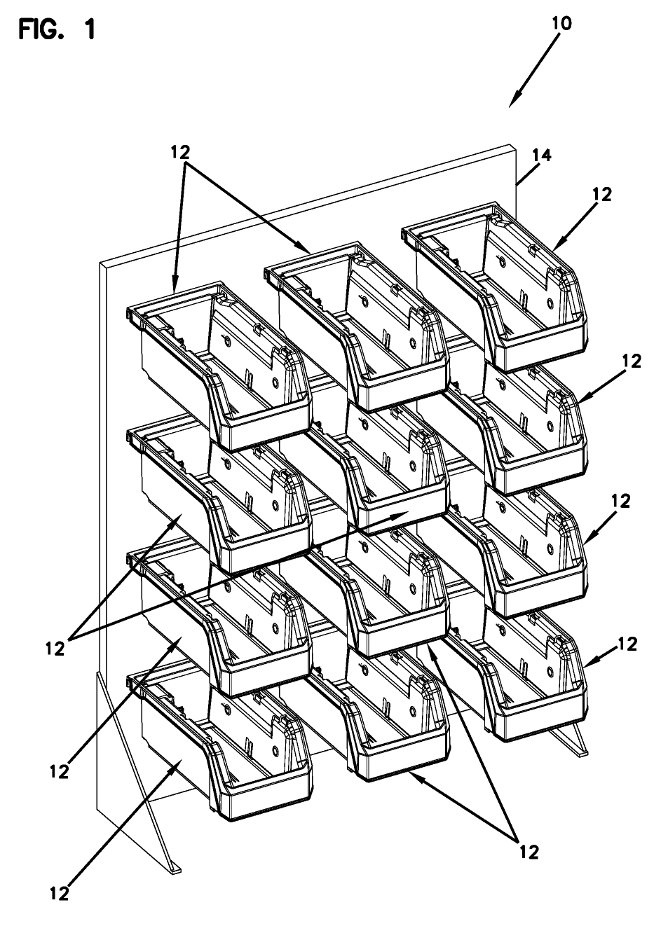

With reference to the FIGS., a system for monitoring bin levels according to principles of the present disclosure is described in more detail below. An embodiment of the inventory management system is shown in FIG. 1. In the depicted embodiment, the inventory management system 10 includes a plurality of bins 12 arranged in an array. In the depicted embodiment, the bins 12 are the same sizes; however, it should be appreciated that they could also be of different sizes. In the depicted embodiment, the bins 12 are supported on a shelf/rack system 14. The shelf/rack system can include a plurality of vertically spaced apart shelves that the bins rest on or alternatively the system could be configured to support the rear portion of the rack such that the bins cantilever outwardly from the rear back panel of the shelf/rack system. In the depicted embodiment, each of the bins 12 is engaged with the shelf such that it can be removed from the shelf/rack system without the use of tools. This configuration allows for easy relocation of the bins 12 and easy replenishment of the bins 12. It should be appreciated that many other configurations are also possible.

In the depicted embodiment at least some of the bins include an outer shell that has a bottom panel 18, opposed side walls 20, 22, a back wall 24, and an open top 26. In the depicted embodiment, each of side walls 20, 22 include an upper portion 28 and a lower portion 30.

In the depicted embodiment, the system includes at least two lower sensors 32, 34 that are mounted adjacent the lower portion 30 of at least one of the side walls 20. Each sensor 32, 34 is configured to determine the absence or presence of material located in the bin 12 adjacent the sensor 32, 34. In the depicted embodiment, at least two upper sensors 36, 38 are mounted adjacent the upper portion 28 of at least one of the side walls 20. Each sensor 36, 38 is configured to determine the absence or presence of material located in the bin adjacent the sensor 36, 38.

In the depicted embodiment, the system is configured to determine whether the bins 12 are in an out of stock state or a sufficiently full state based on the signals from the lower and upper sensors 32, 34, 36, 38. In the depicted embodiment, the controller 40 is remote relative to the shelf/rack system 14 and is operatively connected via a wireless wires system to the plurality of bins 12. In an alternative embodiment, the controller 40 can be wired to the sensors 32, 34, 36, 38 that are mounted adjacent the side walls of the bins 12. In the depicted embodiment, the sensors are optical sensors such as, for example, infrared sensors. It should be appreciated that many other sensor types and configurations are also possible.

In the depicted embodiment, the system includes four low sensors 32, 34, 42, 44 mounted adjacent to the lower portion 30 of at least one of the side walls 20 and four upper sensors 36, 38, 45, 46 mounted adjacent the upper portion 28 of the bin 12. In the depicted embodiment, the lower sensors 32, 34, 42, 44 and upper sensors 36, 38, 45, 46 are arranged in spaced apart vertical columns. In the depicted embodiment, the sensors are arranged in four columns including a middle column 48 located in a mid-portion of the bin in the front to back direction, a forward column 50 located forward of the middle column 48, and a rearward column 52 located rearward of the middle column 48.

In the depicted embodiment, the upper portion 28 includes a lower section 54 and an upper section 56. A first group of sensors are mounted to the lower section 54 and second group of sensors are mounted in the upper section 56. In the depicted embodiment, either the first group or the second group are configured act as the upper sensors 36, 38, 46. If the sufficiently full state is desired to be lower in the bin 12, the first group of sensors will be assigned as the upper sensors 36, 38, 46. On the other hand, if the sufficiently full state is desired to be higher in the bin 12, the second group of sensors will be assigned as the upper sensors 36, 38, 46. It should be appreciated that in some embodiment, higher resolution is desired and both the first group and second group of sensors are activated at the same time and additional intermediate states can be ascertained.

In the depicted embodiment, the sensors are mounted to a circuit board assembly. In the depicted embodiment, the circuit board assembly includes a first board 58, a second board 60, and a ribbon strip 62 that connects the first board to the second board. In the depicted embodiment, a removable battery is slidably connected to the first board. In the depicted embodiment, each sensor include a transmitter (e.g., light emitters) connected to the first board 58 and a corresponding receiver that are connected to the second board 60.

In the depicted embodiment, the circuit board assembly is sandwiched between the outer shell 64 of the bin 12 and a protective insert 66. In the depicted embodiment, the protective insert 60 is constructed and arranged to secure the circuit board assembly in place and protect it from being damaged from the content housed in the bins (parts, fasteners, etc.). In the depicted embodiment, the protective insert 66 is constructed of a material that is sufficiently translucent to allow for the proper function of the sensors, which in the depicted embodiment are infrared sensors. The circuit board assembly can be secure to either the shell of the bin or the protective insert 66 (e.g., the circuit board can be snap fit to the protective insert).

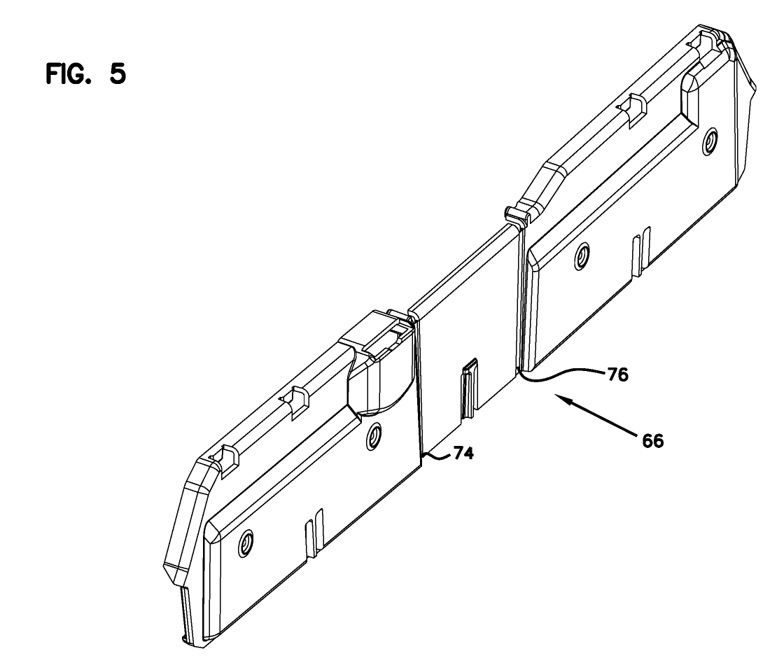

In the depicted embodiment the protective insert 66 includes a first side wall 68, a second side wall 70, and a rear wall 72, and an open top and bottom. In the depicted embodiment, the protective insert includes living hinges 74, 76 between each of the wall which allows the component to be manufacture as a generally flat single piece (see FIG. 5). In the depicted embodiment, the protective insert 66 includes a plurality of structural features that interlock with the inside surface of the outer shell such that the insert snap into place and will not accidently release from the outer shell once engaged with the outer shell. The protective insert can however be removed and replaced for service of the circuit board assembly and/or to replace the battery 64.

It should be appreciated that many other alternative sensor configurations are possible including different types of sensors and different arrangements of the sensors. In an alternative embodiment, the bin 12 may, or may not, include a protective insert. For example, in an alternative embodiment the sensors are secure in recesses on the external surface of the side wall 20 of the bins 12.

In the depicted embodiment, the system determines that the bins are in the out of stock state when a certain number or proportion of the sensor detect an absence of material. In the depicted embodiment, the sensors are spaced in a grid array along the side of the bin. In the depicted embodiment, the vertical and horizontal spacing of the sensors is generally uniform (e.g., the sensors are not all grouped together in one area of the bin). Accordingly, the number or proportion of sensors detecting an absence of material is correlated with whether the bin requires replenishment. Therefore, the server working with other components (e.g., controller) can be configured to send alerts depending on the number of sensor that detect an absence of materials. The server working with other components (e.g., controller) can be likewise configured to send alerts based on the proportion (percentage) of sensors that detect an absence of materials. In one embodiment, the sensors are assigned weights, the weights of each sensor that is a first state (or analogously in a second state) are added together and compared against predetermined volumetric data for the particular material to estimate the quantity of material in the bin. This method empirically accounts for the size and geometry of the material in the bin. This method allows the system, for example, to use the same bin to estimate the number of washers remaining in a bin (e.g., 0-10,000) and also estimate the amount of HVAC elbows (e.g., 0-6) remaining in a bin based on the states of the sensors.

In an alternative embodiment, the system can be configured to determine when the alerts need to be sent based on information from the sensors that are tied to the location of the particular sensor. For example, in one embodiment the server determines that the bins 12 are in the sufficiently full state when all of the lower 32, 34 and upper sensors 36, 38 detect the presence of material. In the depicted embodiment, the system is configured to further determine if any of the bins are in a low state, which represents a state between the out of stock state and the sufficiently full state. In the depicted embodiment, the controller determines that a bin is in a low state when all of the lower sensors 32, 34 detect the presence of material and at least one of the upper sensors 36, 38 detect an absence of material. In the above described embodiment, the system takes into account the sensor location in making its determinations. In the depicted embodiment, the controller continuously monitors the sensors and provides the states of the plurality of bins in real-time.

In the depicted embodiment, the system is configured to transmit the determined state of the sensors to a server. In the depicted embodiment, the server determines whether the bins are in an out of stock state, below minimum state or a sufficiently full state based on the state of the sensors. The system is configured to generate and send an automatic alert to a supplier (e.g., a parts supplier such as Fastenal) when a bin is in the out of stock state. The system can include a user interface that displays bins and provides a color code indicating the state of the bin. In the depicted embodiment the user interface is part of a website that can be accessed by the part suppler as well as the purchaser of the parts. In the depicted embodiment, the bins are configured to hold parts such as fasteners. However, it should be appreciated that the bins could be holding other materials as well and the inventory system could be used in a number of different context other than in industrial whole sale distribution.

In the depicted embodiment, the bins may also include RFID (radio frequency identification) and the shelf/rack system can also include an RFID enclosure or staging area with an RFID reader 78. In the depicted embodiment, if the bin is placed in a particular location on the shelf/rack system (e.g. an enclosure) the RFID reader 78 will detect its presence of the bin. The information would be transmitted wirelessly to a controller 40 via one or more repeaters 80. In the depicted embodiment, the server is configured to determine when the bin requires replenishment based on its location and alert a user accordingly. The system can track the location of the bin to ascertain whether it is waiting to be replenished, being replenished, or has been replenished and returned to its assigned location. Many other alternative configurations and related methods are possible.

A related method of inventory management is also provided. In the depicted embodiment, the method comprising the step of: providing a plurality of bins, each bin including a plurality of optical level sensors mounted thereon; process the data collected from the sensors to determine whether the bin is in an out of stock state or a sufficiently full state; visually displaying the state of the bins; and generate automatic alerts for replenishment based on information regarding the states of the bins from the controller.

The above specification, examples and data provide a complete description of the manufacture and use of the composition of the invention. Since many embodiments of the invention can be made without departing from the spirit and scope of the invention, the invention resides in the claims hereinafter appended.

1. An inventory management system comprising:
a plurality of bins arranged in an array, wherein at least some of the bins have a bottom panel, opposed side walls, a back wall, and an open top, wherein each of the side wall includes an upper portion and a lower portion;
at least two lower sensors mounted to the lower portion of at least one of the side walls, each sensor configured to be in at least a first state which corresponds to the absence of material located in the bin adjacent the sensor and a second state which corresponds to the presence of material located in the bin adjacent the sensor;
at least two upper sensors mounted to the upper portion of at least one of the side walls, each sensor configured to be in at least a first state which corresponds to the absence of material located in the bin adjacent the sensor and a second state which corresponds to the presence of material located in the bin adjacent the sensor; and
a controller configured to aggregate the sensor states.

2. The system of claim 1, wherein the controller is configured to communicate the sensor states to a server and wherein the server determines whether the bins are in an out of stock state, below minimum state or a sufficiently full state based on the states of the sensors.

3. The system of claim 1, wherein the server is configured to estimate the amount of a particular material in a bin based on comparing the sum of the weights assigned to each sensor that are a first state and comparing the sum to a predetermined volumetric data for the particular material.

4. The system of claim 1, further comprising a radio frequency identification reader configured to track the location of at least some of the bins.

5. The system of claim 1, wherein all sensors are arranged in spaced apart in vertical columns and horizontal rows.

6. The system of claim 1, wherein all sensors are arranged uniformly in an array along the side walls of the opposed side walls of the bin.

7. The system of claim 1, wherein the controller is configured to transmit the determined states of the sensors to a server, wherein the server is configured to calculate bin fullness measure and send an automatic alert to a supplier when a bin level falls below predetermined fullness measure.

8. The system of claim 1, further comprising a repeater configured to communicate with the bins using a wireless transceiver to communicate the state of the sensors in the bins to the controller.

9. The system of claim 8, wherein the repeater is battery powered and untethered via wires.

10. The system of claim 1, wherein the system includes a user interface that displays bins and provides a color code indicating the state of the bin.

11. The system of claim 1, wherein the system includes a user interface that is used as a diagnostic and installation tool.

12. The system of claim 1, wherein the sensors, controller and wireless transceiver are powered by batteries.

13. The system of claim 1, wherein the sensors are selected from a group comprising of: optical sensors, infrared sensors, capacitive sensors, and inductive sensors.

14. The system of claim 1, wherein the controller is configured to collect and transmit the states of the plurality of sensors in continuously in real-time.

15. The system of claim 1, wherein the controller is configured to collect and transmit the states of the plurality of sensors at a determined interval.

16. The system of claim 1, wherein the sensors are secure in an inner sleeve affixed the internal opposed surface of the side walls of the bins.

17. The system of claim 1, wherein the sensors are wirelessly connected.

18. The system of claim 1, wherein the sensors are configured to read through the side walls of the protective insert and are secured to the protective insert.

19. The system of claim 1, wherein the plurality of bins includes bins of different sizes.

20. The system of claim 1, wherein the plurality of bins are supported on a louvered rack.

21. A method of live inventory management comprising the step of: providing a plurality of bins, each bin including a plurality of infrared or optical or capacitive level sensors mounted thereon; processing data collected from the sensors to determine whether the bin in in an out of stock state or a sufficiently full state; visually displaying the state of the bins; and generating automatic alerts for replenishment based on information regarding the states of the bin's sensors from the controller.
